(19) United States
(12) Patent Application Publication
(10) Pub. No.: US 2005/0261159 A1
(43) Pub. Date: Nov. 24, 2005

(54) Detergent composition comprising at least one semi-crystalline polymer and at least one oil

(76) Inventors: Eric Parris, Clichy (FR); Jonathan Gawtrey, Boulogne (FR)

Correspondence Address: Thomas L. Irving;FINNEGAN, HENDERSON, FARABOW, GARRETT & DUNNER L.L.P., 1300 I Street, N.W., Washington, DC, 20005-3315, US

(21) Appl. No.: 11/014,704

(22) Filed: Dec. 20, 2004

Related U.S. Application Data
(60) Provisional application No. 60/532,940, filed on Dec. 30, 2003.

(30) Foreign Application Priority Data
Dec. 19, 2003 (FR) 0351142

(51) Int. Cl. C11D 3/37

(52) U.S. Cl. 510/475

(57) ABSTRACT

The present disclosure discloses detergent compositions comprising, in a cosmetically acceptable medium, at least one semi-crystalline polymer in combination with at least one oil and at least one anionic and/or nonionic detergent surfactant. These compositions may be used as shampoo and make it possible to obtain good conditioning properties of keratinous substances.

This application claims benefit of U.S. Provisional Application No. 60/532,940, filed Dec. 30, 2003.

The present disclosure relates to detergent compositions comprising at least one semi-crystalline polymer in combination with at least one oil, and to cosmetic treatment processes, for example treatment processes for keratinous substances such as hair, employing this composition.

In the field of cosmetics, one of the aims of the present disclosure is to improve the conditioning of keratinous substances such as hair. The term “conditioning,” as used herein, includes the properties of easy disentangling, of sheen, of softness to the touch, of tactile and visual smoothness and of sleekness

The use of semi-crystalline polymers is known in cosmetics, for example in the field of makeup, as is disclosed in French Patent Application No. 2,824,267. Cosmetic compositions with a fatty phase gelled by semi-crystalline polymers have been disclosed in French Patent Application No. 2,824,264. This patent application also discloses solid lipstick compositions in the form of a stick.

U.S. Pat. Nos. 5,736,125 and 5,156,911, and publication WO 01/19333, illustrate certain types of semi-crystalline polymers that can be used in the compositions made according to the present disclosure. Nevertheless, these documents do not disclose detergent cosmetic compositions.

The applicant has surprisingly found that, by using at least one semi-crystalline polymer in combination with at least one oil in detergent compositions for treatment of keratinous substances such as hair, it is possible to obtain a very good conditioning of these substances.

The keratinous substances treated with these compositions are smooth, are glossy, are soft, and have a soft and residue-free feel. In addition, the keratin fibers treated with these compositions disentangle easily and have separate individual fibers.

Without being committed to any one theory, it would appear that, under these conditions, the deposition of oil on keratinous substances is significantly increased, resulting in an increased effectiveness. However, this improvement is made without having a heavy greasy feel, which is usually the case when the amount of oil is increased.

Furthermore, this conditioning effect can persist even after rinsing.

Thus, one aspect of the disclosure relates to detergent compositions, for example cosmetic detergent compositions, comprising, in a cosmetically acceptable medium, at least one anionic or nonionic detergent surfactant and at least one semi-crystalline polymer, in one embodiment having a melting point of greater than or equal to 30° C., in combination with at least one oil.

The present disclosure also relates to processes for the cosmetic treatment of keratinous substances employing compositions according to the disclosure.

Other characteristics, aspects and advantages of the disclosure will become evident upon reading the description and the various examples that follow.

According to the disclosure, the detergent compositions comprise at least one semi-crystalline polymer in combination with at least one oil and at least one anionic or nonionic detergent surfactant.

According to one embodiment, the oil may be prethickened by the semi-crystalline polymer, that is to say that the at least one oil and the at least one semi-crystalline polymer may be mixed before introduction into the compositions.

The oil(s)/semi-crystalline polymer(s) ratio by weight can be greater than or equal to 50/50, for example greater than or equal to 60/40, such as from 60/40 to 99/1, or even from 80/20 to 99/1.

This at least one oil, which may be prethickened, can be dispersed in the form of particles in the compositions. For example, the oil particles can exhibit a number-average primary size ranging from 1 to 100 μm (microns), such as from 5 to 30 μm, or even

The term “particle primary size,” as used herein, means the maximum dimension that can be measured between two diametrically opposite points of an individual particle. The size can be determined, for example, by transmission electron microscopy, by measurement of the specific surface using the BET method, or by using a laser particle sizer.

The term “polymers,” as used herein, means compounds comprising at least 2 repeating units, for example at least 3 repeating units, such as at least 10 repeating units.

The term “semi-crystalline polymer,” as used herein, means polymers comprising a crystallizable part and an amorphous part in the backbone, and exhibiting a first-order reversible phase change temperature, such as a melting point. The crystallizable part can be a side or pendent chain, or a block in the backbone.

When the crystallizable part is a block of the polymer backbone, the chemical nature of this crystallizable block is different from that of the amorphous block. In this case, the at least one semi-crystalline polymer is a block copolymer, for example of the diblock, triblock or multiblock type. When the crystallizable part is a chain pendent to the backbone, the at least one semi-crystalline polymer can be a homopolymer or a copolymer.

The term “crystallizable chain or block,” as used herein, means a chain or block which, if it were alone, would change reversibly from the amorphous state to the crystalline state, depending on whether the temperature was above or below the melting point. The term “chain,” as used herein, means a group of atoms that is pendent or lateral relative to the backbone of the polymer. The term “block,” as used herein, means a group of atoms belonging to the backbone that constitutes one of the repeat units of the polymer.

The terms “organic compound” or “with an organic structure,” as used herein, mean compounds comprising carbon atoms, hydrogen atoms, and optionally heteroatoms, such as sulfur, oxygen, nitrogen, or phosphorus, alone or in combination.

The terms “Cₓ-C_{y}” and “from Cₓ to C_{y},” as used herein, means a hydrocarbon chain having from x to y carbons.

The term “alkyl,” as used herein, means a saturated group, for example a saturated C₈-C₂₄ group, unless specifically mentioned.

Semi-Crystalline Polymers

According to one embodiment, the at least one semi-crystalline polymer comprised in the compositions according to the disclosure has a weight-average molecular mass Mw greater than or equal to 1000. The weight-average molecular mass may thus, range from 5000 to 1 000 000, for example from 10 000 to 500 000, such as from 15 000 to 500 000.

The at least one semi-crystalline polymer may comprise i) a polymer backbone and ii) at least one crystallizable side chain and/or one crystallizable organic block forming part of the backbone of the polymer.

The at least one semi-crystalline polymer may be chosen, for example, from at least one of block copolymers comprising at least one crystallizable block and at least one amorphous block, homopolymers, and copolymers bearing at least one crystallizable side chain per repeat unit.

The at least one semi-crystalline polymer according to the disclosure may act as a structuring agent and may be solid at room temperature (25° C.) and atmospheric pressure (760 mm of Hg). Its melting point may be greater than or equal to 30° C., ranging, for example, from 30° C. to 80° C., such as from 30° C to 70° C. This melting point is a first-order change of state temperature. This melting point can be measured by any known method, for example by using a differential scanning calorimeter (DSC).

The melting point values may correspond to the melting point measured using a DSC, such as the calorimeter sold under the name DSC 30 by Mettler, with a heating rate of 5 or 10° C. per minute. In these measurements, the melting point corresponds to the temperature of the most endothermic peak of the thermogram.

In general, the at least one semi-crystalline polymer may have a melting point greater than the temperature of the keratinous substrate, for example hair, that the compositions according to the disclosure may be used on.

The at least one semi-crystalline polymer according to the disclosure may be capable, alone or as a mixture, of structuring or thickening the oil without addition of specific surfactants or of salt.

According to the disclosure, the at least one semi-crystalline polymer may be soluble in the fatty phase, for example to at least 1% by weight, at a temperature greater than its melting point. According to one embodiment, apart from the crystallizable chains or blocks, the blocks of the polymers are amorphous.

The polymer backbone of the at least one semi-crystalline polymer may be soluble in the liquid fatty phase.

According to one embodiment, the crystallizable blocks or chains of the at least one semi-crystalline polymer represent at least 30% of the total weight of each polymer, for example at least 40%. The at least one semi-crystalline polymer with crystallizable side chains may be a homo- or copolymer. The at least one semi-crystalline polymer with crystallizable blocks may be a block or multiblock copolymer. It may be obtained by polymerizing a monomer containing reactive double (or ethylenic) bonds or by polycondensation. When the polymers of the disclosure are polymers with crystallizable side chains, these polymers may be in random form.

According to another embodiment, the at least one semi-crystalline polymer of the disclosure is synthetic in origin. In addition, it may lack a polysaccharide backbone.

By way of non-limiting example, the semi-crystalline polymer that may be used in the disclosure may include:
block copolymers of polyolefins with controlled crystallization, such as those whose monomers are disclosed in European Patent Application No. EP-A-0,951,897;
polycondensates, for example polyester polycondensates, such as aliphatic or aromatic polyesters or aliphatic/aromatic copolyesters;
homo- or copolymers bearing at least one crystallizable side chain and homo- or copolymers bearing in the backbone at least one crystallizable block, such as those disclosed in U.S. Pat. No. 5,156,911;
homo- or copolymers bearing at least one crystallizable side chain, for example, with at least one fluorinated group, as disclosed in the document WO-A-01/1 9333, and
mixtures thereof.
   In the third and fourth examples, the crystallizable side chain(s) or block(s) may be hydrophobic.

A) Semi-Crystalline Polymers Comprising Crystallizable Side Chains

By way of non-limiting example, the semi-crystalline polymers comprising crystallizable side chains include those defined in U.S. Pat. No. 5,156,911 and Patent Publication No. WO 01/19333. These polymers are homopolymers or copolymers comprising from 50% to 100% by weight of units resulting from the polymerization of at least one monomer bearing a crystallizable hydrophobic side chain. According to these publications, the homo- or copolymers may be of any nature, provided that they exhibit the conditions indicated below, for example, the characteristic of being soluble or dispersible in the liquid fatty phase when heated above their melting point. They can result:
from the polymerization, for example, the free-radical polymerization, of at least one monomer containing reactive or ethylenic double bond(s) with respect to polymerization, for example, a vinyl, (meth)acrylic or allyl group;
from the polycondensation of at least one monomer bearing co-reactive groups (carboxylic acid, sulfonic acid, alcohol, amine and isocyanate), such as, for example, polyesters, polyurethanes, polyethers, polyureas and polyamides.

Generally, the crystallizable units (chains or blocks) of the at least one semi-crystalline polymer according to the disclosure may be obtained from monomer(s) with crystallizable block(s) or chain(s) used for the manufacture of the at least one semi-crystalline polymer. These polymers may be chosen, for example, from the homopolymers and copolymers resulting from the polymerization of at least one monomer comprising at least one crystallizable chain that can be represented by formula (I): 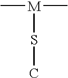
wherein M is an atom of the polymer backbone, S is a spacer and C is a crystallizable group.

The crystallizable chains “—S—C” may be chosen from optionally fluorinated and perfluorinated aliphatic and aromatic chains. “S” may be chosen from linear, branched, and cyclic (CH₂)ₙ, (CH₂CH₂O)ₙ, and (CH₂O)ₙ groups, with n being an integer ranging from 0 to 22. According to one embodiment, “S” is a linear group. According to another embodiment, “S” and “C” are different.

When the crystallizable chains are hydrocarbonaceous aliphatic chains, they can comprise hydrocarbonaceous alkyl chains comprising at least 11 carbon atoms and not more than 40 carbon atoms, for example not more than 24 carbon atoms. They may be aliphatic chains or alkyl chains comprising at least 12 carbon atoms, for example, C₁₄-C₂₄ alkyl chains, such as C₁₆-C₂₂ alkyl chains. When they are fluorinated or perfluorinated alkyl chains, they can comprise at least 11 carbon atoms, at least 6 carbon atoms of which are fluorinated.

Non-limiting examples of semi-crystalline homopolymers or copolymers comprising crystallizable chain(s) include those resulting from the polymerization of at least one of the following monomers: saturated alkyl (meth)acrylates, in which the alkyl is a C₁₄-C₂₄ group; perfluoroalkyl (meth)acrylates, in which the perfluoroalkyl is a C₁₁-C₁₅ group; N-alkyl(meth)acrylamides, in which the alkyl is a C₁₄-C₂₄ group with or without a fluorine atom; vinyl esters comprising alkyl or perfluoroalkyl chains, in which the alkyl is a C₁₄-C₂₄ group, and each perfluoroalkyl chain contains at least 6 fluorine atoms; vinyl ethers comprising alkyl or perfluoroalkyl chains, in which the alkyl is a C₁₄-C₂₄ group, and each perfluoroalkyl chain comprises at least 6 fluorine atoms; C₁₄-C₂₄ α-olefins, such as, for example, octadecene; para-alkylstyrenes, in which the alkyl is a C₁₂-C₂₄; and mixtures thereof.

When the semi-crystalline polymers result from a polycondensation, the crystallizable hydrocarbonaceous and/or fluorinated chains as defined above are borne by a monomer that may be a diacid, a diol, a diamine, or a diisocyanate.

When the semi-crystalline polymers that are used in compositions according to the disclosure are copolymers, they additionally comprise from 0 to 50% of Y or Z groups resulting from the copolymerization:
i) of Y, which is a polar or nonpolar monomer or a mixture thereof. When Y is a polar monomer, it may be chosen from monomers bearing polyoxyalkylenated groups, such as oxyethylenated and/or oxypropylenated groups; hydroxyalkyl (meth)acrylates, such as hydroxyethyl acrylate; (meth)acrylamide; N-alkyl(meth)acrylamides; N,N-dialkyl(meth)acrylamides, such as, for example, N,N-diisopropylacrylamide or N-vinylpyrrolidone (NVP); N-vinylcaprolactam; monomers bearing at least one carboxylic acid group, such as (meth)acrylic acid, crotonic acid, itaconic acid, maleic acid or fumaric acid, or bearing a carboxylic acid anhydride group, such as maleic anhydride;

and mixtures thereof. When Y is a nonpolar monomer, it may be chosen from linear, branched and cyclic alkyl (meth)acrylate monomers; vinyl esters; alkyl vinyl ethers; α-olefins; styrenes and styrenes substituted by a C₁ to C₁₀ alkyl group, such as α-methylstyrene; and polyorganosiloxane macromonomers containing vinyl unsaturation.
ii) of Z, which is a polar monomer or a mixture of polar monomers. In this case, Z has the same definition as the “polar Y” defined above.

According to one embodiment, the at least one semi-crystalline polymer comprising a crystallizable side chain is chosen from alkyl (meth)acrylate and alkyl(meth)acrylamide homopolymers with an alkyl group as defined above, such as a C₁₄-C₂₄ alkyl group; copolymers of these monomers with a hydrophilic monomer, such as those different in nature from (meth)acrylic acid, such as N-vinylpyrrolidone and hydroxyethyl (meth)acrylate; and mixtures thereof.

B) Polymers Bearing at Least one Crystallizable Block in Their Backbone

Polymers bearing at least one crystallizable block in their backbone may be polymers that are soluble or dispersible in the liquid fatty phase when they are heated above their melting point. For example, these polymers may be block copolymers composed of at least two blocks of different chemical natures, one of which is crystallizable.

The polymers bearing at least one crystallisable block in their backbone that may be used in compositions according to the disclosure include those defined in U.S. Pat. No. 5,156,911.

Further non-limiting examples of polymers bearing at least one crystallisable block in their backbone that may be used in compositions according to the disclosure include block copolymers of olefin or of cycloolefin comprising a crystallizable chain, for example those resulting from the block polymerization of:
cyclobutene, cyclohexene, cyclooctene, norbornene (also known as bicyclo[2.2.1]hept-2-ene), 5-methylnorbornene, 5-ethyinorbornene, 5,6-dimethyinorbornene, 5,5,6-trimethyinorbornene, 5-ethylidenenorbornene, 5-phenylnorbornene, 5-benzylnorbornene, 5-vinylnorbornene, 1,4,5,8-dimethano-1,2,3,4,4a,5,8a-octahydronaphthalene, dicyclopentadiene, or mixtures thereof,
with ethylene, propylene, 1-butene, 3-methyl-1-butene, 1-hexene, 4-methyl-1-pentene, 1-octene, 1-decene, 1-icosene, or mixtures thereof.
   These block copolymers include block copoly(ethylene/norbornene)s and (ethylene/propylene/ethylidenenorbornene) block terpolymers. Block polymers resulting from the block copolymerization of at least 2 C₂-C₁₆ α-olefins, for example C₂-C₁₂ α-olefins such as those mentioned above, may also be used in compositions according to the disclosure, as may block bipolymers of ethylene and of 1-octene.

The copolymers may be copolymers comprising at least one crystallizable block, the remainder of the copolymer being amorphous at room temperature. These copolymers may, in addition, comprise two crystallizable blocks of different chemical nature. Suitable copolymers include, but are not limited to, those that have, at room temperature, both a crystallizable block and an amorphous block that are sequentially distributed, where the amorphous block is both hydrophobic and lipophilic. Such polymers include, but are not limited to, those comprising one of the crystallizable blocks and one of the amorphous blocks below:
blocks that are crystallizable by nature, for example polyester, such as poly(alkylene terephthalate)s, and polyolefin, such as polyethylenes and polypropylenes,
amorphous and lipophilic blocks, such as amorphous polyolefins and copoly(olefin)s, for example poly(isobutylene), hydrogenated polybutadiene and hydrogenated poly(isoprene).

Examples of such copolymers comprising a crystallizable block and an amorphous block include, but are not limited to:
i) poly(ε-caprolactone)-b-poly(butadiene) block copolymers, used for example hydrogenated, such as those described in the paper, “Melting behavior of poly(ε-caprolactone)-block-polybutadiene copolymers,” by S. Nojima, Macromolecules, 32, 3727-3734 (1999),
ii) block or multiblock hydrogenated poly(butylene terephthalate)-b-poly(isoprene) block copolymers, cited in the paper, “Study of morphological and mechanical properties of PP/PBT,” by B. Boutevin et al., Polymer Bulletin, 34, 117-123 (1995),
iii) the poly(ethylene)-b-copoly(ethylene/propylene) block copolymers cited in the papers, “Morphology of semi-crystalline block copolymers of ethylene-(ethylene-alt-propylene),” by P. Rangarajan et al., Macromolecules, 26, 4640-4645 (1993), and “Polymer aggregates with crystalline cores: the system poly(ethylene)-poly(ethylene-propylene),” by P. Richter et al., Macromolecules, 30, 1053-1068 (1997),
iv) The poly(ethylene)-b-poly(ethylethylene) block copolymers cited in the general article, “Crystallization in block copolymers,” by I. W. Hamley, Advances in Polymer Science, 148, 113-137 (1999).

The at least one semi-crystalline polymer used in the compositions according to the disclosure may or may not be partially crosslinked, provided that the degree of crosslinking does not interfere with their dissolution or dispersion in the liquid fatty phase when they are heated above their melting point. The crosslinking may be chemical crosslinking, by reaction with a multifunctional monomer during the polymerization. It may also be physical crosslinking, in which case the crosslinking is achieved either by the establishment of hydrogen bonds or dipolar bonds between groups borne by the polymer, such as, for example, dipolar interactions between carboxylate ionomers, these interactions being low in number and borne by the backbone of the polymer, or by phase separation between the crystallizable blocks and the amorphous blocks carried by the polymer.

According to one embodiment, the at least one semi-crystalline polymer that may be used in the compositions is not crosslinked.

According to another embodiment, the polymer is chosen from the copolymers resulting from the polymerization of at least one monomer with a crystallizable chain, chosen from saturated C₁₄-C₂₄ alkyl (meth)acrylates; C₁₁-C₁₅ perfluoroalkyl (meth)acrylates; N—(C₁₄-C₂₄ alkyl)(meth)acrylamides, with or without a fluorine atom; vinyl esters comprising C₁₄-C₂₄ alkyl or perfluoroalkyl chains; vinyl ethers comprising C₁₄-C₂₄ alkyl or perfluoroalkyl chains; C₁₄-C₂₄ α-olefins; and para-alkylstyrenes comprising C₁₂-C₂₄ alkyl groups, with at least one optionally fluorinated C₁-C₁₀ monocarboxylic acid ester or amide, which may be represented by the following formula: 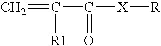
wherein R₁ is chosen from H and CH₃; R is chosen from optionally fluorinated C₁-C₁₀ alkyl groups; and X is chosen from O, NH and NR₂, in which R₂ represents optionally fluorinated C₁-C₁₀ alkyl groups.

Examples of structuring semi-crystalline polymers that may be used in the compositions according to the disclosure include, but are not limited to, the Intelimer® products from Landec described in the brochure “Intelimer® polymers,” Landec IP22 (Rev. 4-97). These polymers are in solid form at room temperature (25° C.). They bear crystallizable side chains and exhibit the above formula (I).

In the rest of the disclosure, semi-crystalline polymers with a melting point M.p.₂ of less than 50° C. will be called “polymers with a low melting point,” and crystalline or semi-crystalline compounds with a melting point M.p.₁ of greater than or equal to 50° C. will be called “compounds with a high melting point.” According to the disclosure, the melting point can be measured by any known method, for example with a differential scanning calorimeter (DSC).

According to the disclosure, semi-crystalline compounds with a high melting point may be polymers with a melting point M.p.₁ such that 50° C.≦M.p.₁≦150° C., for example 55° C. ≦M.p.₁≦150° C., such as 60° C. ≦M.p.₁<130° C., and polymers with a low melting point may have a melting point M.p.₂ such that 30° C. ≦M.p.₂<50° C., for example 35° C.≦M.p.₂≦45° C. This melting point is a first-order change of state temperature.

Generally, polymers with a low melting point may have a melting point M.p.₂ at least equal to the temperature of the keratinous substrate on which the compositions according to the disclosure are placed.

Examples of semi-crystalline polymers with a high melting point that may be used in the disclosure include, but are not limited to, crystalline polymers that are solid at room temperature and that have a melting point of greater than 50° C., for example random polymers comprising controlled crystallization, as disclosed in the European Patent Application EP-A-0,951,897, such as the commercial products Engage 8 401 and Engage 8 402 from Dupont de Nemours, which have melting points of 51° C. and 64° C., respectively, and which are random ethylene/1-octene bipolymers.

Further examples of semi-crystalline polymers with a melting point of greater than or equal to 50° C. include, but are not limited to, the Intelimer described in the brochure “Intelimer® polymers,” Landec IP22, with a melting point of 56° C., which is a viscous product at room temperature; semi-crystalline polymers obtained by copolymerization of behenyl acrylate and of acrylic acid or of NVP, as disclosed in U.S. Pat. No. 5,519,063 and European Patent Application No. EP-A-0,550,745; and those described in Examples 1 and 2 below.

Examples of semi-crystalline polymers with a melting point of less than 50° C. include, but are not limited to, those with a —COOH group described in Examples 3, 4, 5, 7 and 9 of U.S. Pat. No. 5,156,911, which are made by copolymerization of acrylic acid and of C₅-C₁₆ alkyl (meth)acrylate and which have a melting point ranging from 20° C. to 35° C., such as those made by copolymerization:
of acrylic acid, of hexadecyl acrylate, and of isodecyl acrylate in a 1/16/3 ratio,
of acrylic acid and of pentadecyl acrylate in a 1/19 ratio,
of acrylic acid, of hexadecyl acrylate, and of ethyl acrylate in a 2.5/76.5/20 ratio,
of acrylic acid, of hexadecyl acrylate, and of methyl acrylate in a 5/85/10 ratio,
of acrylic acid and of octadecyl methacrylate in a 2.5/97.5 ratio,
of hexadecyl acrylate, of polyethylene glycol monomethyl ether methacrylate with 8 ethylene glycol units, and of acrylic acid in an 8.5/1/0.5 ratio by weight.

Other examples of polymers that may be used in the compositions according to the disclosure include, but are not limited to, the polymer Structure “O” from National Starch, such as that disclosed in the U.S. Pat. No. 5,736,125, with a melting point of 44° C., and semi-crystalline polymers with crystallizable pendent chains comprising fluorinated groups, such as those disclosed in Examples 1, 4, 6, 7 and 8 of the document WO-A-01/19333.

Examples of semi-crystalline polymers of low melting point that may be used according to the disclosure include, but are not limited to, those obtained by copolymerization of stearyl acrylate and of acrylic acid or of NVP, as disclosed in U.S. Pat. No. 5,519,063 and European Patent No. EP-A-550 745, and those described in Example 3 below, with a melting point of 48° C.

Examples of semi-crystalline polymers that may be used according to the disclosure include, but are not limited to, those obtained by copolymerization of behenyl acrylate and of acrylic acid or of NVP, as disclosed in U.S. Pat. No. 5,519,063 and European Patent Application EP-A-0,550,745.

According to one embodiment, the semi-crystalline polymers with a low melting point and/or those with a high melting point do not comprise a carboxyl group.

According to another embodiment of the disclosure, the at least one polymer is made from a monomer with a crystallizable chain chosen from saturated C₁₄-C₂₄ alkyl (meth)acrylates, for example from poly(stearyl acrylate)s and poly(behenyl acrylate)s.

The thickening of the fatty phase may be adjusted according to the nature of the at least one polymer and its concentration, and may be such that a viscosity ranging from 1000 cP to 250 000 cP, for example from 10 000 cP to 50 000 cP, measured at 25° C. with a Rheomat 180 device with a shear rate of 100 s⁻¹, is obtained.

The at least one semi-crystalline polymer as defined above may be present in an amount ranging from 0.005% to 20% by weight, relative to the total weight of the composition, for example from 0.05% to 10% by weight, relative to the total weight of the composition, such as from 0.1% to 5% by weight, relative to the total weight of the composition.

The term “oil,” as used herein, means a water-insoluble fatty substance that is liquid at room temperature (25° C.) and atmospheric pressure (760 mm of Hg). The oily phase may be composed of one or more oils that are compatible with one another.

The term “water-insoluble,” as used herein, means a substance that has a solubility in pure water of less than 1% at 25° C. and at atmospheric pressure.

The oils used in the present disclosure may exhibit a dynamic viscosity at 25° C. of less than 1 Pa.s (1000 cP), for example ranging from 10⁻³ to 0.1 Pa.s (1 cP and 100 cP). The dynamic viscosity is measured at 25° C. with a shear rate of 100 s⁻¹, for example using a device such as the Rheomat RM 180 from Mettler.

The oils that can be used in the present disclosure may be chosen from vegetable oils, mineral oils, synthetic oils and fatty acid esters.

Examples of vegetable oils that may be used in the present disclosure include, but are not limited to, sweet almond oil, avocado oil, castor oil, olive oil, jojoba oil, sunflower oil, wheat germ oil, sesame oil, groundnut oil, grape seed oil, soybean oil, rapeseed oil, safflower oil, coconut oil, maize oil, hazelnut oil, karite butter, palm oil, apricot kernel oil, and calophyllum oil.

Examples of mineral oils include, but are not limited to, liquid paraffin and liquid petrolatum.

The synthetic oils may be chosen from polydecenes; squalane; poly(α-olefin)s, such as isododecane and isohexadecane; transesterified vegetable oils; and fluorinated oils.

By way of non-limiting example, fatty acid esters that may be used include the compounds of formula RₐCOOR_{b}, in which Rₐ may be chosen from residues of higher fatty acids comprising from 5 to 29 carbon atoms and R_{b} may be chosen from hydrocarbonaceous chains comprising from 3 to 30 carbon atoms, such as purcellin oil (stearyl octanoate), isopropyl myristate, isopropyl palmitate, butyl stearate, hexyl laurate, diisopropyl adipate, isononyl isononanoate, 2-ethylhexyl palmitate, 2-hexyldecyl laurate, 2-octyldecyl palmitate, 2-octyidodecyl myristate, and 2-octyidodecyl lactate.

In one embodiment, the oils may be chosen from avocado oil, castor oil, olive oil, hydrogenated polydecene, isopropyl myristate, isononyl isononanoate, and a liquid paraffin.

The at least one oil may be present in the compositions according to the disclosure in an amount ranging from 0.01% to 30% by weight, relative to the weight of the composition, for example in an amount ranging from 0.1% to 15% by weight, relative to the weight of the composition, such as from 0.5% to 10% by weight, relative to the weight of the composition.

The anionic or nonionic detergent surfactants may have an hydrophile-lipophile balance of greater than or equal to 8, for example of greater than 12, such as less than 30.

Anionic detergent surfactants that may be used, alone or as mixtures, in the context of the present disclosure include, but are not limited to, salts, for example alkali metal salts, such as sodium salts, ammonium salts, amine salts, aminoalcohol salts and alkaline earth metal salts, for example magnesium salts and salts of compounds chosen from alkyl sulfates, alkyl ether sulfates, alkylamido ether sulfates, alkylarylpolyether sulfates, monoglyceride sulfates, alkylsulfonates, alkyl phosphates, alkylamidesulfonates, alkylarylsulfonates, α-olefinsulfonates, paraffinsulfonate, alkyl sulfosuccinates, alkyl ether sulfosuccinates, alkylamide sulfosuccinates, alkyl sulfoacetates, acylsarcosinates, and acylglutamates, all of which may contain an alkyl or acyl group comprising from 6 to 24 carbon atoms andan aryl group that may be a phenyl or benzyl group. Further examples of anionic detergents that may be used include, but are not limited to, C₆-C₂₄ alkyl esters of polyglycosidecarboxylic acids, such as alkyl glucosidecitrates, alkyl polyglycosidetartrates and alkyl polyglycosidesulfosuccinates; compounds such as alkyl sulfosuccinamates, acyl isethionates, and N-acyltaurates, all of which may contain analkyl or acyl group comprising from 12 to 20 carbon atoms. Still further examples of anionic surfactants that may be used include C₈-C₂₀ acyllactylates.

Further examples of anionic surfactants that may be used according to the disclosure include, but are not limited to, alkyl-D-galactosideuronic acids and their salts; polyoxyalkylenated (C₆-C₂₄)alkyl ether carboxylic acids, polyoxyalkylenated (C₆-C₂₄)alkyl(C₆-C₂₄)aryl ether carboxylic acids, polyoxyalkylenated (C₆-C₂₄)alkylamido ether carboxylic acids and their salts, such as those comprising from 2 to 50 ethylene oxide groups; and mixtures thereof.

In one embodiment according to the disclosure, the anionic surfactant may be chosen from salts, for example sodium, magnesium and ammonium salts, of alkyl sulfates, of alkyl ether sulfates, for example sodium lauryl ether sulfate, such as that with 2 or 3 mol of ethylene oxide,and of alkyl ether carboxylates; and mixtures thereof. In this embodiment, the alkyl groups generally comprise from 6 to 24 carbon atoms, for example from 8 to 16 carbon atoms.

The nonionic surface-active agents that may be used in the compositions according to the disclosure are compounds well known per se (see in this respect “Handbook of Surfactants” by M. R. Porter, published by Blackie & Son (Glasgow and London), 1991, pp. 116-178). Thus, they can be chosen from, but are not limited to, polyethoxylated, polypropoxylated and polyglycerolated fatty acids, (C₁-C₂₀)alkylphenols, α-diols and alcohols, all of which may contain a fatty chain comprising, for example, from 8 to 18 carbon atoms, and all of which may contain from 2 to 50 ethylene oxide and propylene oxide groups and from 2 to 30 glycerol groups. They may also be chosen from copolymers of ethylene oxide and of propylene oxide, condensates of ethylene oxide and of propylene oxide with fatty alcohols; polyethoxylated fatty amides that may contain from 2 to 30 mol of ethylene oxide, and polyglycerolated fatty amides comprising on average from 1 to 5 glycerol groups, such as from 1.5 to 4; polyethoxylated fatty amines that may contain 2 to 30 mol of ethylene oxide; sorbitan ethoxylated fatty acid esters containing from 2 to 30 mol of ethylene oxide; sucrose fatty acid esters, polyethylene glycol esters of fatty acids, (C₆-C₂₄)alkylpolyglycosides, such as (C₈-C₁₆)alkylpolyglycosides, and N-(C₆-C₂₄)alkylglucamine derivatives; amine oxides, such as oxides of (C₁₀-C₁₄)alkylamines and N—(C₁₀-C₁₄)-acylaminopropylmorpholine oxides; and mixtures thereof.

With regard to the alkylpolyglycosides, these compounds are well known and may be represented by the following general formula (A):
R₁O—(R₂O)ₜ(G)ᵥ
wherein:
R₁ is chosen from linear and branched alkyl and/or alkenyl radicals comprising approximately from 8 to 24 carbon atoms; and alkylphenyl radicals, the linear or branched alkyl radical of which comprises from 8 to 24 carbon atoms;
R₂ is chosen from alkylene radicals comprising approximately from 2 to 4 carbon atoms;
G is chosen from sugar units comprising from 5 to 6 carbon atoms;
t is a value ranging from 0 to 10, for example from 0 to 4; and
v is a value ranging from 1 to 15.

In one embodiment according to the present disclosure, alkylpolyglycosides are chosen from compounds of formula (A) in which R₁ is chosen from saturated and unsaturated, linear and branched alkyl radicals comprising from 8 to 18 carbon atoms; t is a value ranging from 0 to 3, for example 0; and G is be chosen from glucose, fructose and galactose, for example glucose. The degree of polymerization, i.e. the value of v in the formula (A), can range from 1 to 15, for example from 1 to 4. The degree of polymerization may even range from 1 to 2.

The glycoside bonds between the sugar units may be1-6 or 1-4 bonds, such as 1-4 bonds.

Examples of compounds of formula (A) include, but are not limited to, the products sold by Cognis under the names Plantaren® (600 CS/U, 1200 and 2000) and Plantacare® (818, 1200 and 2000); the products sold by Seppic under the names Triton CG 110 (also known as Oramix CG 110) and Triton CG 312 (also known as Oramix® NS 10); the products sold by BASF under the name Lutensol GD 70; and those sold by Chem Y under the name AG10 LK.

Another non-limiting example is the C₈/C₁₆ alkyl 1,4-polyglucoside in 53% aqueous solution sold by Cognis under the name Plantacare® 818 UP.

With regard to the mono- or polyglycerolated surfactants, they may comprise on average from 1 to 30 glycerol groups, for example from 1 to 10 glycerol groups, such as from 1.5 to 5.

The monoglycerolated or polyglycerolated surfactants may be chosen from the compounds of following formulae: RO[CH₂CH(CH₂OH)O]ₘH, RO[CH₂CH(OH)CH₂O]ₘH, and RO[CH(CH₂OH)CH₂O]ₘH, in which R may be chosen from saturated and unsaturated, linear and branched hydrocarbonaceous radicals comprising from 8 to 40 carbon atoms, for example from 10 to 30 carbon atoms, and m is a number from 1 to 30, for example from 1 to 10, such as from 1.5 to 6.

R may optionally comprise heteroatoms, such as, for example, oxygen and nitrogen. R may also optionally comprise at least one hydroxyl and/or ether and/or amide groups.

In one embodiment of the present disclosure, R is chosen from C₁₀-C₂₀ alkyl and/or alkenyl radicals that are optionally mono- or polyhydroxylated.

A non-limiting example of a surfactant that may be used in the compositions according to the present disclosure is the polyglycerolated (3.5 mol) hydroxylauryl ether sold under the name Chimexane® NF by Chimex.

Examples of nonionic surfactants that may be used in the compositions according to the present disclosure include, but are not limited to, (C₆-C₂₄)alkylpolyglycosides, polyglycerolated alcohols, polyglycerolated α-diols, and mixtures thereof.

The at least one anionic and/or nonionic surfactant may be present in the compositions according to the present disclosure in an amount ranging from 3% to 50% by weight, relative to the total weight of the detergent composition, for example from 4% to 30% by weight, relative to the total weight of the detergent composition, such as from 5% to 20% by weight, relative to the total weight of the detergent composition, and even from 10% to 18% by weight, relative to the total weight of the detergent composition.

The detergent compositions according to the disclosure may additionally comprise at least one zwitterionic and/or amphoteric surfactant and optionally nondetergent surfactants, for example nonionic nondetergent surfactants.

Examples of amphoteric surface-active agents that are suitable for use the compositions according to the present disclosure may be chosen from, but are not limited to, derivatives of aliphatic secondary and tertiary amines, in which the aliphatic group may be a linear or branched chain comprising 8 to 22 carbon atoms and at least one water-solubilizing anionic group, such as, for example, a carboxylate, sulfonate, sulfate, phosphate or phosphonate group; (C₈-C₂₀)alkylbetaines, sulfobetaines, (C₈-C₂₀)alkylamido(C₆-C₈)alkylbetaines and (C₈-C₂₀)alkylamido(C₆-C₈)alkylsulfobetaines; and mixtures thereof.

Examples of amine derivatives include, but are not limited to, the products sold under the name Miranol®, as disclosed in U.S. Pat. Nos. 2,528,378 and 2,781,354 and classified in the CTFA dictionary, 3rd edition, 1982, under the names Amphocarboxyglycinate and Amphocarboxypropionate, with the respective structures (2) and (3):
R₂—CONHCH₂CH₂—N⁺(R₃)(R₄)(CH₂COO⁻) (2)
R_{2′}—CONHCH₂CH₂—N(B)(C) (3)
wherein:
R₂ is chosen from alkyl radicals derived from R₂—COOH acids present in hydrolyzed coconut oil; and heptyl, nonyl and undecyl radicals;
R₃ is a β-hydroxyethyl group;
R₄ is a carboxymethyl group;
B is —CH₂CH₂OX′;
C is —(CH₂)_{z}—Y′, with z=1 or 2;
X′ is chosen from a —CH₂CH₂—COOH group and a hydrogen atom;
Y′ is chosen from a —COOH group and a —CH₂—CHOH—SO₃H group;
R_{2′} is chosen from alkyl groups of R_{2′}—COOH acids present in coconut oil or in hydrolyzed linseed oil; alkyl groups, for example C₁₇ alkyl groups and their iso forms; and unsaturated C₁₇ groups.

These compounds are classified in the CTFA dictionary, 5th Edition, 1993, under the names Disodium Cocoamphodiacetate, Disodium Lauroamphodiacetate, Disodium Caprylamphodiacetate, Disodium Capryloamphodiacetate, Disodium Cocoamphodipropionate, Disodium Lauroamphodipropionate, Disodium Caprylamphodipropionate, Disodium Capryloamphodipropionate, Lauroamphodipropionic acid, and Cocoamphodipropionic acid.

An example of an amine derivative is the cocoamphodiacetate sold under the trade name Miranol® C2M concentrate by Rhodia.

According to an embodiment of the present disclosure, the amphoteric surfactants that may be used are chosen from (C₈-C₂₀)alkylbetaines, (C₈-C₂₀)alkylamido-(C₆-C₈)alkylbetaines, alkylamphodiacetates, and mixtures thereof.

The amphoteric and/or nonionic surfactants may optionally be present in the compositions according to the present disclosure in an amount ranging from 0.1% to 20% by weight, relative to the total weight of the detergent composition, for example from 0.5% to 15% by weight, relative to the total weight of the detergent composition, such as from 1% to 10% by weight, relative to the total weight of the detergent composition.

The compositions according to the disclosure can additionally comprise at least one cationic polymer. The cationic polymers that may be used in accordance with the present disclosure can be chosen from, but are not limited to, all those already known per se as improving the cosmetic properties of the hair, for example those disclosed in European Patent Application No. EP-A-0,337,354 and in French Patent Application Nos. 2,270,846, 2,383,660, 2,598,611, 2,470,596 and 2,519,863.

The expression “cationic polymer,” as used herein, means any polymer comprising cationic groups and/or groups that can be ionized to give cationic groups.

Cationic polymers that may be used in the compositions according to the disclosure include, but are not limited to, those that comprise units bearing primary, secondary, tertiary and/or quaternary amine groups that can either form part of the main polymer chain or be carried by a side substituent directly connected to the main chain.

The cationic polymers used generally have a number- or weight-average molar mass ranging from 500 to 5×10⁶, for example from 10³ to 3×10⁶.

According to one embodiment, cationic polymers that may be used in the compositions according to the disclosure are chosen from polyamine, polyaminoamide and poly(quaternary ammonium) polymers. These are known products.

Polyamine, polyaminoamide, and poly(quaternary ammonium) polymers that may be used in the compositions in accordance with the present disclosure include those disclosed in French Patent Nos. 2,505,348 and 2,542,997. Examples of these polymers include, but are not limited to:
(1) Homopolymers or copolymers that are derived from compounds chosen from acrylic and methacrylic esters, and amides that comprise at least one of the units of the following formulae: 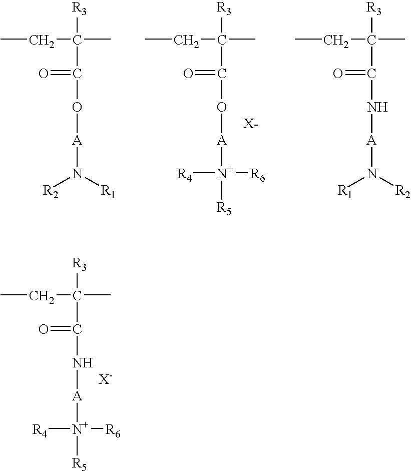
   wherein:
R₃, which may be identical or different, is chosen from hydrogen and CH₃ radicals;
A, which may be identical or different, is chosen from linear and branched alkyl groups comprising from 1 to 6 carbon atoms, for example 2 or 3 carbon atoms, and hydroxyalkyl groups comprising 1 to 4 carbon atoms;
R₄, R₅ and R₆, which may be identical or different, is chosen from alkyl groups comprising from 1 to 18 carbon atoms, for example from 1 to 6 carbon atoms, and benzyl radicals;
R₁ and R₂, which may be identical or different, is chosen from hydrogen and alkyl groups having from 1 to 6 carbon atoms, for example methyl and ethyl;
X is chosen from anions derived from inorganic and organic acids, for example methyl sulfate anions and halides, such as chloride and bromide.

The copolymers of family (1) may additionally comprise at least one unit derived from comonomers that may be chosen from, but are not limited to, acrylamides, methacrylamides, diacetone acrylamides, acrylamides and methacrylamides substituted on the nitrogen by lower (C₁l-C₄) alkyls; acrylic acids, methacrylic acids, and their esters; vinyllactams, such as vinylpyrrolidone and vinylcaprolactam; and vinyl esters.

Non-limiting examples of copolymers of family (1) include:
copolymers of acrylamide and of dimethylaminoethyl methacrylate that is quaternized with dimethyl sulfate or with a dimethyl halide, such as that sold under the name Hercofloc by Hercules,
copolymers of acrylamide and of methacryloyloxyethyltrimethylammonium chloride, disclosed, for example, in European Patent Application EP-A-80,976, and sold under the name Bina Quat P 100 by Ciba-Geigy,
the copolymer of acrylamide and of methacryloyloxyethyltrimethylammonium methyl sulfate, sold under the name Reten by Hercules,
copolymers of vinylpyrrolidone and of dialkylaminoalkyl acrylate or methacrylate, which may or may not be quaternized, described in detail in French Patent Nos. 2,077,143 and 2,393,573, and sold for example under the name “Gafquat” by ISP, such as “Gafquat 734” and “Gafquat 755,” and the products named “Copolymer 845, 958 and 937”,
dimethylaminoethyl methacrylate/vinylcaprolactam/vinylpyrrolidone terpolymers, such as the product sold under the name Gaffix VC 713 by ISP,
vinylpyrrolidone/methacrylamidopropyidimethylamine copolymers, such as the product sold under the name Styleze CC 10 by ISP, and
vinylpyrrolidone/quaternized dimethylaminopropylmethacrylamide copolymers, such as the product sold under the name “Gafquat HS 100” by ISP.
(2) Cationic polysaccharides, for example cationic celluloses and cationic galactomannan gums. Examples of cationic polysaccharides include, but are not limited to, cellulose ether derivatives comprising quaternary ammonium groups, cationic cellulose copolymers, cellulose derivatives grafted with a water-soluble quaternary ammonium monomer, and cationic galactomannan gums.

Non-limiting examples of cellulose ether derivatives comprising quaternary ammonium groups include those disclosed in French Patent 1,492,597, and those sold, for example, under the names “JR” (JR 400, JR 125, JR 30M) and “LR” (LR 400, LR 30M) by Amerchol. These polymers are also defined in the CTFA dictionary as quaternary ammoniums of hydroxyethylcellulose that have reacted with an epoxide substituted by a trimethylammonium group.

Non-limiting examples of cationic cellulose copolymers and cellulose derivatives grafted with a water-soluble quaternary ammonium monomer include those disclosed in U.S. Pat. No. 4,131,576, for example hydroxyalkyl celluloses, such as hydroxymethyl, hydroxyethyl, and hydroxypropyl celluloses, grafted for example with a methacryloyloxyethyltrimethylammonium, methacrylamido-propyltrimethylammonium or dimethyldiallylammonium salt. These polymers are sold under the name “Celquat L 200” and “Celquat H 100” by National Starch, for example.

Non-limiting examples of cationic galactomannan gums include those disclosed in U.S. Pat. Nos. 3,589,578 and 4,031,307, for example guar gums comprising trialkylammonium cationic groups. In accordance with one embodiment, guar gums modified by a 2,3-epoxypropyltrimethylammonium salt, such as 2,3-epoxypropyltrimethylammonium chloride, may be used in the compositions according to the disclosure. These polymers are sold, for example, under the trade names Jaguar C13 S, Jaguar C 15, Jaguar C 17, and Jaguar C162 by Rhodia.
(3) Polymers comprising piperazinyl units and radicals chosen from straight and branched alkylene and hydroxyalkylene divalent radicals, optionally interrupted by oxygen, sulfur or nitrogen atoms or by aromatic or heterocyclic rings, and the oxidation and/or quaternization products of these polymers. Non-limiting examples of such polymers include those disclosed in French Patent Nos. 2,162,025 and 2 280 361.
(4) Water-soluble polyaminoamides prepared for example by polycondensation of an acidic compound with a polyamine. These polyaminoamides may be crosslinked by a compound chosen from epihalohydrins, diepoxides, dianhydrides, unsaturated dianhydrides, bisunsaturated derivatives, bishalohydrins, bisazetidiniums, bishaloacyldiamines, and alkyl bishalides, or by an oligomer resulting from the reaction of a bifunctional compound reactive with respect to a compound chosen from bishalohydrins, bisazetidiniums, bishaloacyidiamines, alkyl bishalides, epihalohydrins, diepoxides, and bisunsaturated derivatives. The crosslinking agent may be used in proportions ranging from 0.025 mol to 0.35 mol per amine group of the polyaminoamide. These polyaminoamides may be alkylated or, if they comprise at least one tertiary amine functional group, quaternized. Non-limiting examples of such polymers include those disclosed in French Patent Nos. 2,252,840 and 2,368,508.
(5) Polyaminoamide derivatives resulting from the condensation of polyalkylenepolyamines with polycarboxylic acids, followed by an alkylation by bifunctional agents. Examples of such polymers include, but are not limited to, adipic acid/dialkylaminohydroxyalkyldialkylenetriamine polymers in which the alkyl radical comprises from 1 to 4 carbon atoms, such as methyl, ethyl or propyl. Such polymers are disclosed for example in French Patent 1,583,363.

Non-limiting examples of polyaminoamide derivatives include the adipic acid/dimethylaminohydroxypropyl/diethylenetriamine polymers sold under the name “Cartaretin F, F4 or F8” by Sandoz.
(6) Polymers obtained by reaction of a polyalkylenepolyamine comprising two primary amine groups and at least one secondary amine group with a dicarboxylic acid chosen from diglycolic acid and saturated aliphatic dicarboxylic acids comprising from 3 to 8 carbon atoms. The molar ratio of polyalkylene-polyamine to dicarboxylic acid may be between 0.8:1 and 1.4:1. The polyaminoamide resulting therefrom may then be reacted with epichlorohydrin in a molar ratio of epichlorohydrin in relation to the secondary amine group of the polyaminoamide of from 0.5:1 to 1.8:1. Such polymers are disclosed for example in U.S. Pat. Nos. 3,227,615 and 2,961,347.

Non-limiting examples of polymers of this type include those sold under the name “Hercosett 57” by Hercules Inc. and under the names “PD 170” and “Delsette 101” by Hercules in the case of the adipic acid/epoxypropyl/diethylenetriamine copolymer.
(7) Cyclopolymers of alkyldiallylamine or of dialkyldiallylammonium, such as the homopolymers or copolymers comprising, as main constituent of the chain, units chosen from the formulae (II) and (III): 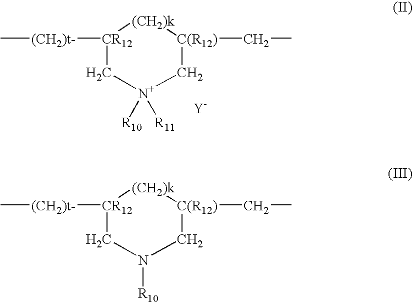
   wherein:
formulae k and t are equal to 0 or 1, and the sum k+t is equal to 1;
R₁₂ is chosen from hydrogen and methyl radicals;
R₁₀ and R₁₁, which may be identical or different, are chosen from alkyl groups comprising from 1 to 6 carbon atoms; hydroxyalkyl groups in which the alkyl group may comprise from 1 to 5 carbon atoms; lower (C₁-C₄) amidoalkyl groups; and, when the nitrogen atoms to which they are attached is included in the group, heterocyclic groups, such as piperidinyl and morpholinyl;
Y⁻ is chosen from anions, such as bromide, chloride, acetate, borate, citrate, tartrate, bisulfate, bisulfite, sulfate and phosphate.
   These polymers are disclosed, for example, in French Patent 2,080,759 and in its certificate of addition 2,190,406.

According to one embodiment, R₁₀ and R₁₁, which may be identical or different, are chosen from alkyl groups comprising from 1 to 4 carbon atoms.

Non-limiting examples of this type of polymer include the homopolymer of dimethyldiallylammonium chloride sold under the name “Merquat 100” by Nalco, and its homologues of low weight-average molar masses, and the copolymers of diallyldimethylammonium chloride and of acrylamide sold under the name “Merquat 550.”
(8) The quaternary diammonium polymers comprising repeat units of formula (IV): 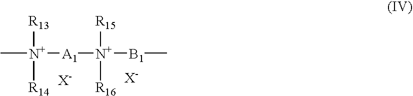
   wherein:
R₁₃, R₁₄, R₁₅ and R₁₆, which may be identical or different, are chosen from aliphatic, alicyclic and arylaliphatic radicals comprising from 1 to 20 carbon atoms; lower aliphatic hydroxyalkyl radicals; when the nitrogen atoms to which they are attached is included in the group, heterocycles optionally comprising a second heteroatom other than nitrogen; and linear and branched C₁-C₆ alkyl radicals substituted by groups chosen from nitriles, esters, acyls, amides, —CO—O—R₁₇-D, and —CO—NH—R₁₇-D, wherein R₁₇ is an alkylene and D a quaternary ammonium group;
A₁ and B₁ are chosen from linear and branched, saturated and unsaturated polymethylene groups comprising from 2 to 20 carbon atoms that can comprise, bonded to or inserted into the main chain, one or more aromatic rings, one or more oxygen or sulfur atoms, and groups chosen from sulfoxide, sulfone, disulfide, amino, alkylamino, hydroxyl, quaternary ammonium, ureido, amide, and ester;
X⁻ is chosen from anions derived from inorganic and organic acids;
A₁, R₁₃ and R₁₅ may form, with the two nitrogen atoms to which they are attached, a piperazine ring;
if A₁ is chosen from linear and branched, saturated and unsaturated alkylene and hydroxyalkylene radicals, B₁ can be chosen from —(CH₂)ₙ—CO-D-OC—(CH₂)ₙ— groups in which D is chosen from:
   a) a glycol residue of formula: —O-Z-O—, where Z is chosen from linear and branched hydrocarbonaceous radicals, and groups corresponding to one of the following formulae:
      —(CH₂—CH₂—O)ₓ—CH₂—CH₂—
      —[CH₂—CH(CH₃)—O]_{y}—CH₂—CH(CH₃)—
      where x and y are chosen from integers from 1 to 4 when they represent a defined and unique degree of polymerization, or any number from 1 to 4 when they represent a mean degree of polymerization;
   b) a bissecondary diamine residue, such as a piperazine derivative;
   c) a bisprimary diamine residue of formula —NH—Y—NH—, where Y is chosen from linear and branched hydrocarbonaceous radicals, and the divalent radical
      —CH₂—CH₂—S—S—CH₂—CH₂—;
   d) a ureylene group of formula —NH—CO—NH—.

According to one embodiment, X⁻ is an anion, such as chloride or bromide.

These polymers generally have a number-average molar mass ranging from 1000 to 100 000.

Polymers of this type are disclosed, for example, in French Patent Nos. 2,320,330, 2,270,846, 2,316,271, 2,336,434, and 2,413,907, and U.S. Pat. Nos. 2,273,780, 2,375,853, 2,388,614, 2,454,547, 3,206,462, 2,261,002, 2,271,378, 3,874,870, 4,001,432, 3,929,990, 3,966,904, 4,005,193, 4,025,617 4,025,627, 4,025,653, 4,026,945, and 4,027,020.

Non-limiting examples of polymers that may be used in the compositions according to the disclosure include those composed of repeat units corresponding to the formula (V): 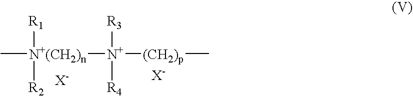
wherein:
R₁, R₂, R₃ and R₄, which may be identical or different, are chosen from alkyl and hydroxyalkyl radicals comprising from 1 to 4 carbon atoms;
n and p are chosen from integers from 2 to 20; and
X⁻ is chosen from anions derived from inorganic and organic acids.

According to one embodiment, the compound of formula (V) is that for which R₁, R₂, R₃ and R₄ are methyl radicals, n=3, p=6, and X═Cl. This compound is known as Hexadimethrine chloride according to the INCI (CTFA) nomenclature.
(9) Poly(quaternary ammonium) polymers comprising units of formula (VI): 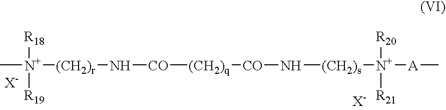
   wherein:
R₁₈, R₁₉, R₂₀ and R₂₁, which may be identical or different, are chosen from hydrogen, and methyl, ethyl, propyl, β-hydroxyethyl, β-hydroxypropyl and —CH₂CH₂(OCH₂CH₂)ₚOH radicals, wherein p is chosen from 0 and integers from 1 to 6, and wherein R₁₈, R₁₉, R₂₀ and R₂₁ do not simultaneously represent a hydrogen atom;
r and s, which may be identical or different, are chosen from integers from 1 to 6;
q is chosen from 0 and integers from 1 to 34;
X⁻ is chosen from anions, such halides;
A is chosen from dihalide radicals, such as —CH₂—CH₂—O—CH₂—CH₂—.

Such compounds are disclosed, for example, in European Patent Application EP-A-122,324.

Non-limiting examples of these polymers include the products “Mirapol® A 15,” “Mirapol® AD1,” “Mirapol® AZ1,” and “Mirapol® 175,” sold by Miranol.
(10) Quaternary polymers of vinylpyrrolidone and of vinylimidazole, such as, for example, the products sold under the names Luviquat® FC 905, FC 550 and FC 370 by BASF.
(11) Polyamines, such as Polyquart® H sold by Cognis, referenced under the name of “Polyethylene Glycol (15) Tallow Polyamine” in the CTFA dictionary.
(12) Polymers of methacryloyloxy(C₁-C₄)alkyltri(C₁-C₄)alkylammonium salts that may be crosslinked, such as polymers obtained by homopolymerization of dimethylaminoethyl methacrylate quaternized by methyl chloride or by copolymerization of acrylamide with dimethylaminoethyl methacrylate quaternized by methyl chloride, the homo- or copolymerization being followed by a crosslinking by a compound possessing olefinic unsaturation, for example methylenebisacrylamide. According to one embodiment, the compositions according to the disclosure may comprise a crosslinked acrylamide/methacryloyloxyethyltrimethylammonium chloride (20/80 by weight) copolymer in the form of a dispersion comprising 50% by weight of the said copolymer in mineral oil. This dispersion is sold for example under the name of “Salcare® SC 92” by Ciba. According to another embodiment, the compositions according to the disclosure may comprise a crosslinked homopolymer of methacryloyloxyethyltrimethylammonium chloride comprising approximately 50% by weight of the homopolymer in mineral oil or in a liquid ester. These dispersions are sold for example under the names of “Salcare® SC 95” and “Salcare® SC 96” by Ciba.

Non-limiting examples of other cationic polymers that can be used in the context of the disclosure are cationic proteins or cationic protein hydrolysates; polyalkyleneimines, for example polyethyleneimines; polymers comprising vinylpyridine or vinylpyridinium units; condensates of polyamines and of epichlorohydrin; quaternary polyureylenes; and chitin derivatives.

According to one embodiment, the cationic polymers that may be used in the compositions in accordance with the disclosure include quaternary cellulose ether derivatives, such as the products sold under the name “JR 400” by Amerchol; cationic cyclopolymers, for example the homopolymers or copolymers of dimethyidiallylammonium chloride sold under the names “Merquat 100,” “Merquat 550,” and “Merquat S” by Nalco; quaternary polymers of vinylpyrrolidone and of vinylimidazole; optionally crosslinked homopolymers and copolymers of methacryloyloxy(C₁-C₄)alkyltri(C₁-C₄)alkylammonium salts; and mixtures thereof.

The at least one cationic polymer may be present at concentrations ranging from 0.01% to 20%, by weight, relative to the total weight of the composition, for example from 0.05% to 10%, by weight, relative to the total weight of the composition, such as from 0.1% to 5% by weight, relative to the total weight of the composition.

The term “cosmetically acceptable medium,” as used herein, means a medium compatible with the keratinous substances such as the hair, but also with a pleasant smell, a pleasing appearance and a pleasant touch.

The cosmetically acceptable medium comprises water or a mixture of water and of a cosmetically acceptable solvent chosen from lower C₁-C₄ alcohols, such as ethanol, isopropanol, tert-butanol and n-butanol; polyols, such as glycerol, propylene glycol and polyethylene glycol; and mixtures thereof.

The compositions may comprise from 70% to 95% by weight of water, relative to the total weight of the composition.

The washing compositions according to the disclosure exhibit a final pH ranging from 3 to 10, for example from 4.5 to 8. The pH can be conventionally adjusted to the desired value by adding to the compositions an organic or inorganic base, chosen from aqueous ammonia, and primary, secondary and tertiary (poly)amines, such as monoethanolamine, diethanolamine, triethanolamine, isopropanolamine and 1,3-propanediamine, or an acid, chosen from carboxylic acids, such as, for example, citric acid.

The compositions in accordance with the disclosure may comprise, in addition to the combination defined above, viscosity-regulating agents, such as electrolytes, and associative and non-associative thickening agents. Non-limiting examples of such agents include sodium chloride; sodium xylenesulfonate; scleroglucans; xanthan gums; fatty acid alkanolamides; alkyl ether carboxylic acid alkanolamides optionally oxyethylenated with up to 5 mol of ethylene oxide, such as the product sold under the name “Aminol A15” by Chem Y; and crosslinked poly(acrylic acid)s and crosslinked copolymers of acrylic acid, such as copolymers of acrylic acid and of C₁₀-C₃₀ alkyl acrylates. These viscosity-regulating agents may be used in the compositions according to the disclosure in proportions that can range up to 10% by weight, relative to the total weight of the composition.

The compositions in accordance with the disclosure may additionally comprise up to 5% of pearlescence or opacifying agents well known in the state of the art, chosen from higher C₁₆ fatty alcohols; acylated derivatives with a fatty chain, such as ethylene glycol and polyethylene glycol monostearates and distearates; ethers with fatty (C₁₀-C₃₀) chains, such as, for example, distearyl ether; and 1-(hexadecyloxy)-2-octadecanol.

The compositions in accordance with the disclosure may optionally also comprise at least one additive chosen from foam synergists, such as C₁₀-C₁₈ 1,2-alkanediols and fatty alkanolamides derived from mono- or from diethanolamine; silicone and non-silicone sunscreens; cationic surfactants; proteins; protein hydrolysates; ceramides; pseudoceramides; fatty acids with linear or branched C₁₂-C₄₀ chains, such as 18-methylicosanoic acid; hydroxy acids; vitamins, such as vitamins E, C and B; provitamins, such as panthenol; silicones; animal, mineral and synthetic oils; anionic, cationic, nonionic, amphoteric and zwitterionic polymers different from semi-cristalline polymers according to the disclosure; UV screening agents; fragrances; colorants; natural and synthetic thickeners; C₁₂-C₃₀ fatty alcohols; pearlescence agents; preservatives; pH stabilizing agents; antimicrobial agents; agents for combating dandruff; antiseborrhoeic agents; antioxidants; reducing agents; acidic and alkaline agents; any other additive conventionally used in the cosmetics field that does not affect the properties of the compositions according to the disclosure; and mixtures thereof. According to one embodiment, the compositions contain almost no silicone. According to this embodiment, silicone may comprise less than 1% by weight, relative to the total weight of the composition, for example less than 0.5% by weight, relative to the total weight of the composition, such as 0% by weight, relative to the total weight of the composition.

The washing compositions according to the disclosure may additionally comprise any conventional adjuvant encountered in the field of shampoos, chosen from fragrances, preservatives, sequestering agents, softeners, colorants, moisturizing agents, agents for combating dandruff, antiseborrhoeic agents, and others.

A person skilled in the art will take care to choose this or these optional additional compounds and/or their amounts so that the advantageous properties intrinsically attached to the combination in accordance with the disclosure are not, or not substantially, detrimentally affected by the envisaged addition or additions.

The compositions according to the disclosure may be provided in the form of liquids, optionally thickened liquids, creams and gels, and they are suitable for washing keratinous substances, such as hair. These compositions may be foaming.

The compositions may be packaged in various forms, for example in bottles, pump-action sprays and aerosol containers, in order to provide for application of the compositions in the vaporized form or in the foam form.

The present disclosure also relates to processes for the cosmetic treatment of keratinous substances, comprising applying, to the keratinous substances, an effective amount of a composition as described above, and rinsing, after an optional leave-in time.

The compositions of the disclosure may be provided in the form of an oil-in-water emulsion.

The compositions in accordance with the disclosure may be used as shampoos, for example for keratinous substances such as the hair.

When the compositions in accordance with the disclosure are employed as conventional shampoos, they may be simply applied to a wet keratinous substance, such as hair, and foam may be generated by massaging or rubbing with the hands. After an optional leave-in time, the foam may be removed by rinsing with water. The operation may then be repeated at least once.

The disclosure may be understood more clearly with the aid of the non-limiting examples that follow, which constitute preferred embodiments of the compositions according to the disclosure. Other than in the examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained herein. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope are approximations, the numerical values set forth in the specific example are reported as precisely as possible. Any numerical value, however, inherently contains certain errors necessarily resulting from the standard deviation found in its respective testing measurements.

### EXAMPLES

### Example 1

A semicrystalline homopolymer with a melting point of 58° C. was manufactured. 120 g of Parleam® were placed into a 1 I reactor equipped with a central anchor stirrer, a reflux condenser and a thermometer, and were heated from room temperature to 80° C. over 45 min. At 80° C., the following mixture C₁ was introduced over 2 h: 40 g of cyclohexane+4 g of Trigonox 141 [2,5-bis(2-ethylhexanoylperoxy)-2,5-dimethylhexane].

30 min after starting to add mixture C₁, mixture C₂ was introduced over 1 h 30. This mixture was composed of 200 g of behenyl acrylate+400 g of cyclohexane.

At the end of the two additions, the mixture was allowed to react at 80° C. for an additional 3 h. After that time, all the cyclohexane present in the reaction medium was distilled off at atmospheric pressure. The polymer obtained is at 60% by weight of active material in Parleam®.

Its weight-average molecular mass was of the order of 17 000-27 000 and its melting point M.p. was approximately 58° C., as measured by DSC.

### Example 2

A semicrystalline copolymer with a melting point of 58° C. was manufactured. The same procedure as in Example 1 was applied, except that behenyl acrylate was used instead of stearyl acrylate.

The polymer obtained is at 60% by weight of active material in Parleam®. Its weight-average molecular mass was 23 500-33 500 and its M.p. was approximately 58° C.

### Example 3

A semicrystalline copolymer with a melting point of 48° C. was manufactured. The same procedure as in Example 1 was applied, except that a mixture of 10 g of N-vinylpyrrolidone and of 190 g of stearyl acrylate was used.

The polymer obtained is at 60% by weight of active material in Parleam®. Its weight-average molecular mass was 43 000-53 000 and its M.p. was approximately 48° C.

### Example 4

Mixtures of semi-crystalline polymers and oils shown in the table below were prepared in the ratios shown below:

| | | Oil/polymer | | |
|---|---|---|---|---|
| Oil | Semi-crystalline polymer | ratio | Viscosity | |
| Avocado oil | Poly(C₁₀₋₃₀ alkyl | 96/4 | 9000 | cP |
| | acrylate)⁽²⁾ | | | |
| Isononyl | (C₁₀₋₃₀)Alkyl | 85/15 | 5000 | cP |
| isononanoate | acrylate/methacrylic acid | | | |
| | copolymer | | | |
| Hydrogenated | Poly(C₁₀₋₃₀ alkyl | 95/5 | 13 700 | cP |
| polydecene⁽¹⁾ | acrylate)⁽²⁾ | | | |

⁽¹⁾sold under the name Ceraflow E by Shamrock
⁽²⁾Intelimer IPA13-1, sold by Landec

### Example 5

The following shampoo was prepared. The proportions are shown as % by weight.

| Composition | | Ex. 5 | |
|---|---|---|---|
| 70% Sodium lauryl ether sulfate | | 14 | g (AM) |
| 30% Cocobetaine | | 2.8 | g (AM) |
| Cocamide MIPA⁽¹⁾ | | 1.5 | g (AM) |
| Carbomer⁽²⁾ | | 0.2 | g |
| Hydrogenated polydecene (Ceraflow E) | | 2.83 | g |
| Semi-crystalline polymer: | | 0.17 | g |
| Intelimer IPA13-1, sold by Landec | | | |
| Hydroxystearyl cetyl ether and cetyl alcohol | | 2.5 | g |
| pH agent | q.s. | pH | 7 |
| Preservative | q.s. | | |

| | | |
|---|---|---|
| Water | q.s. for 100 | g |

AM: Active Material
⁽¹⁾sold under the trade name Empilan CIS by Huntsman
⁽²⁾sold under the trade name Carbopol 980 by Noveon

The polydecene was mixed beforehand with the semi-crystalline polymer. The prethickened polydecene was subsequently introduced into the surfactants.

This composition was applied to natural hair, left to act for approximately 3 minutes and rinsed. It had an excellent conditioning effect on the hair.

Similar results were obtained with the polymers of Examples 1 to 3.

1. A detergent composition, comprising, in a cosmetically acceptable medium, at least one semi-crystalline polymer having a melting point of greater than or equal to 30° C., at least one oil, and at least one anionic and/or nonionic detergent surfactant, the composition being provided in the form of an oil-in-water emulsion.

2. The composition according to claim 1, wherein the at least one semi-crystalline polymer has a melting point ranging from 30° C. to 80° C.

3. The composition according to claim 2, wherein the at least one semi-crystalline polymer has a melting point ranging from 30° C. to 70° C.

4. The composition according to claim 1, wherein the at least one semi-crystalline polymer has a weight-average molecular mass of greater than or equal to 1000.

5. The composition according to claim 1, wherein the at least one semi-crystalline polymer has a number-average molecular mass ranging from 5000 to 1 000 000.

6. The composition according to claim 5, wherein the at least one semi-crystalline polymer has a number-average molecular mass ranging from 10 000 to 500 000.

7. The composition according to claim 1, wherein the at least one semi-crystalline polymer comprises i) a polymer backbone and ii) at least one crystallizable side chain and/or one crystallizable organic block forming part of the backbone of the semi-crystalline polymer.

8. The composition according to claim 1, wherein the at least one semi-crystalline polymer is chosen from at least one of block copolymers comprising at least one crystallizable block and at least one amorphous block, and homopolymers and copolymers bearing at least one crystallizable side chain per repeat unit mixtures thereof.

9. The composition according to claim 8, wherein the at least one crystallizable block is different in nature from the at least one amorphous block.

10. The composition according to claim 1, wherein the at least one semi-crystalline polymer has a crystallizable organic chain and/or a crystallizable block present in an amount of at least 30% of the total weight of the polymer.

11. The composition according to claim 10, wherein the at least one semi-crystalline polymer has a crystallizable organic chain and/or a crystallizable block present in an amount of at least 40% of tlhe total weight of the polymer.

12. The composition according to claim 1, wherein the at least one semi-crystalline polymer is chosen from block copolymers of polyolefins with controlled crystallization, polyester polycondensates, and homopolymers and copolymers bearing at least one crystallizable side chain, and mixtures thereof.

13. The composition according to claim 1, wherein the at least one semi-crystalline polymer is chosen from homopolymers and copolymers comprising from 50% to 100% by weight of units resulting from the polymerization of at least one monomer bearing at least one crystallizable hydrophobic side chain.

14. The composition according to claim 1, wherein the at least one semi-crystalline polymer is chosen from homopolymers and block copolymers resulting from the polymerization of at least one monomer comprising, per repeating unit, at least one amorphous block and at least one crystallizable side chain of formula (I): 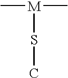
wherein:
M an atom of the polymer backbone;
S is a spacer;
C is chosen from crystallizable groups and mixtures thereof; and
S—C is chosen from optionally fluorinated and perfluorinated alkyl chains comprising at least 11 carbon atoms.

15. The composition according to claim 1, wherein the at least one semi-crystalline polymer is chosen from the polymers resulting from the polymerization of at least one monomer chosen from acrylic acid, methacrylic acid, crotonic acid, itaconic acid, maleic acid, maleic anhydride, and mixtures thereof.

16. The composition according to claim 1, wherein the at least one semi-crystalline polymer is chosen from the homopolymers and copolymers resulting from the polymerization of at least one monomer comprising a crystallizable block, chosen from saturated C₁₄-C₂₄ alkyl (meth)acrylates; C₁₁-C₁₅ perfluoroalkyl (meth)acrylates; N—(C₁₄-C₂₄ alkyl)-(meth)acrylamides, with or without a fluorine atom(s); vinyl esters comprising chains chosen from C₁₄-C₂₄ alkyl and perfluoroalkyl chains; vinyl ethers comprising chains chosen from C₁₄-C₂₄ alkyl and perfluoroalkyl chains; C₁₄-C₂₄ α-olefins; para-alkylstyrenes with an alkyl group comprising from 12 to 24 carbon atoms, and mixtures thereof.

17. The composition according to claim 1, wherein the at least one semi-crystalline polymer is chosen from the copolymers resulting from the polymerization of at least one monomer with a crystallizable chain, chosen from saturated C₁₄-C₂₄ alkyl (meth)acrylates; C₁₁-C₁₅ perfluoroalkyl (meth)acrylates; N—(C₁₄-C₂₄ alkyl)methacrylamides, with or without at least one fluorine atom; vinyl esters comprising chains chosen from C₁₄-C₂₄ alkyl and perfluoroalkyl chains; vinyl ethers comprising chains chosen from C₁₄-C₂₄ alkyl and perfluoroalkyl chains; and C₁₄-C₂₄ α-olefins or para-alkylstyrenes comprising an alkyl group comprising from 12 to 24 carbon atoms, and comprising at least one optionally fluorinated C₁-C₁₀ monocarboxylic acid ester or amide.

18. The composition according to claim 1, wherein the at least one semi-crystalline polymer is chosen from C₁₄-C₂₄ alkyl (meth)acrylate and C₁₄-C₂₄ alkyl(meth)acrylamide homopolymers; and the copolymers of at least one monomer chosen from C₁₄-C₂₄ alkyl (meth)acrylate and C₁₄-C₂₄ alkyl(meth)acrylamide and of a hydrophilic monomer.

19. The composition according to claim 1, wherein the at least one semi-crystalline polymer is chosen from copolymers of at least one monomer chosen from C₁₄-C₂₄ alkyl (meth)acrylate and C₁₄-C₂₄ alkyl(meth)acrylamide and of a hydrophilic monomer.

20. The composition according to claim 19, wherein the hydrophilic monomer is chosen from N-vinylpyrrolidone; hydroxyethyl (meth)acrylate; and mixtures thereof.

21. The composition according to claim 1, wherein the at least one semi-crystalline polymer is derived from a monomer comprising a crystallizable chain chosen from saturated C₁₄-C₂₄ alkyl (meth)acrylates.

22. The composition according to claim 21, wherein the at least one semi-crystalline polymer is derived from a monomer comprising a crystallisable chain chosen from poly(stearyl acrylate)s or poly(behenyl acrylate)s.

23. The composition according to claim 1, wherein the at least one semi-crystalline polymer is present in an amount ranging from 0.005% to 20% by weight, relative to the total weight of the composition.

24. The composition according to claim 23, wherein the at least one semi-crystalline polymer is present in an amount ranging from 0.05% to 10% by weight, relative to the total weight of the composition.

25. The composition according to claim 1, wherein the at least one oil is chosen from vegetable oils, mineral oils, synthetic oils, and fatty acid esters.

26. The composition according to claim 25, wherein the at least one oil is chosen from sweet almond oil, avocado oil, castor oil, olive oil, jojoba oil, sunflower oil, wheat germ oil, sesame oil, groundnut oil, grape seed oil, soybean oil, rapeseed oil, safflower oil, coconut oil, maize oil, hazelnut oil, karite butter, palm oil, apricot kernel oil and calophyllum oil; liquid paraffin and liquid petrolatum; polydecenes, squalane, poly(α-olefin)s, transesterified vegetable oils and fluorinated oils; and compounds of formula RₐCOOR_{b}, in which Rₐ is chosen from residues of higher fatty acids comprising from 5 to 29 carbon atoms and R_{b} is chosen from hydrocarbonaceous chains comprising from 3 to 30 carbon atoms.

27. The composition according to claim 26, wherein the poly(α-olefin)s are chosen from isododecane and isohexadecane.

28. The composition according to claim 27, wherein the at least one oil is chosen from avocado oil, castor oil, olive oil, isohexadecane, polydecene, isopropyl myristate, isononyl isononanoate, and liquid paraffin.

29. The composition according to claim 1, wherein the at least one oil is present in an amount ranging from 0.01% to 30% by weight, relative to the total weight of the composition.

30. The composition according to claim 29, wherein the at least one oil is present in an amount ranging from 0.1% to 15% by weight, relative to the total weight of the composition.

31. The composition according to claim 1, wherein the at least one oil is prethickened by the at least one semi-crystalline polymer.

32. The composition according to claim 1, wherein the ratio by weight of the at least one oil to the at least one semi-crystalline polymer is greater than or equal to 50/50.

33. The composition according to claim 32, wherein the ratio by weight of the at least one oil to the at least one semi-crystalline polymer is greater than or equal to 60/40.

34. The composition according to claim 33, wherein the ratio by weight of the at least one oil to the at least one semi-crystalline polymer ranges from 60/40 to 99/1.

35. The composition according to claim 1, wherein the at least one oil has a number-average primary size ranging from 1 μm to 100 μm.

36. The composition according to claim 35, wherein the at least one oil has a number-average primary size ranging from 5 μm to 30 μm.

37. The composition according to claim 1, wherein the at least one anionic surfactant is chosen from alkali metal salts, ammonium salts, amine salts, aminoalcohol salts and alkaline earth metal salts of compounds chosen from alkyl sulfates, alkyl ether sulfates, alkylamido ether sulfates, alkylarylpolyether sulfates, monoglyceride sulfates, alkylsulfonates, alkyl phosphates, alkylamidesulfonates, alkylarylsulfonates, α-olefinsulfonates, paraffinsulfonates, alkyl sulfosuccinates, alkyl ether sulfosuccinates, alkylamide sulfosuccinates, alkyl sulfoacetates, acylsarcosinates, and acylglutamates, wherein the alkyl and acyl groups comprise from 6 to 24 carbon atoms and the aryl groups are chosen from phenyl and benzyl group; C₆-C₂₄ alkyl esters of polyglycosidecarboxylic acids; and alkyl sulfosuccinamates, acyl isethionates and N-acyltaurates, wherein the alkyl or acyl groups comprise from 12 to 20 carbon atoms.

38. The composition according to claim 37, wherein the at least one anionic surfactant is chosen from salts of alkyl sulfates, of alkyl ether sulfates, optionally with ethylene oxide ranging from 2 to 3 mol, and of alkyl ether carboxylates, wherein the alkyl groups comprise from 6 to 24 carbon atoms.

39. The composition according to claim 1, wherein the at least one nonionic surfactant is chosen from polyethoxylated, polypropoxylated and polyglycerolated fatty acids, (C₁-C₂₀)alkylphenols, α-diols and alcohols, comprising a fatty chain, a number of ethylene oxide or propylene oxide groups ranging from 2 to 50, and a number of glycerol groups ranging from 2 to 30; copolymers of ethylene oxide and of propylene oxide, condensates of ethylene oxide and of propylene oxide with fatty alcohols; polyethoxylated fatty amides having from 2 to 30 mol of ethylene oxide; polyglycerolated fatty amides comprising on average from 1 to 5 glycerol groups; polyethoxylated fatty amines; sorbitan ethoxylated fatty acid esters having from 2 to 30 mol of ethylene oxide; and sucrose fatty acid esters, polyethylene glycol esters of fatty acids, (C₆-C₂₄)alkylpolyglycosides, N—(C₆-C₂₄)alkylglucamine derivatives, amine oxides and N—(C₁₀-C₁₄)acylaminopropylmorpholine oxides.

40. The composition according to claim 39, wherein the polyglycerolated fatty amides comprise from 1.5 to 4 glycerol groups.

41. The composition according to claim 39, wherein the at least one nonionic surfactant is chosen from (C₆-C₂₄)alkylpolyglycosides.

42. The composition according to claim 41, wherein the at least one nonionic surfactant is chosen from (C₈-C₁₆)alkylpolyglycosides.

43. The composition according to claim 1, wherein the at least one anionic and/or nonionic surfactant is present in an amount ranging from 3% to 50% by weight, relative to the total weight of the composition.

44. The composition according to claim 43, wherein the at least one anionic and/or nonionic surfactant is present in an amount ranging from 4% to 30% by weight, relative to the total weight of the composition.

45. The composition according to claim 1, further comprising at least one amphoteric surfactant.

46. The composition according to claim 45, wherein the at least one amphoteric surfactant is chosen from (C₈-C₂₀)alkylbetaines, (C₈-C₂₀)alkylamido(C₆-C₈)alkylbetaines, and alkylamphodiacetates.

47. The composition according to claim 45, wherein the at least one amphoteric surfactant is present in an amount ranging from 0.1% to 20% by weight, relative to the total weight of the composition.

48. The composition according to claim 45, wherein the at least one amphoteric surfactant is present in an amount ranging from 0.5% to 15% by weight, relative to the total weight of the composition.

49. The composition according to claim 1, wherein the cosmetically acceptable medium comprises water and a cosmetically acceptable solvent.

50. The composition according to claim 49, wherein the cosmetically acceptable solvent is chosen from lower C₁-C₄ alcohols and polyols.

51. The composition according to claim 1, further comprising at least one conventional additive chosen from cationic surface-active agents; anionic, cationic, nonionic, amphoteric and zwitterionic polymers; UV screening agents; fragrances; colorants; natural and synthetic thickeners; C₁₂-C₃₀ fatty alcohols; pearlescence agents; preservatives; pH stabilizing agents; vitamins; provitamins; antimicrobial agents; agents for combatting dandruff; antiseborrhoeic agents; antioxidants; reducing agents; and acidic and alkaline agents.

52. The composition according to claim 1, further comprising at least one cationic polymer.

53. The composition according to claim 52, wherein the at least one cationic polymer is chosen from quaternary cellulose ether derivatives, cationic guar gums, cationic cyclopolymers, quaternary polymers of vinylpyrrolidone and of vinylimidazole, and optionally crosslinked homopolymers and copolymers of methacryloyloxy(C₁-C₄)alkyltri(C₁-C₄)alkylammonium salts.

54. The composition according to claim 52, wherein the at least one cationic polymer is present in an amount ranging from 0.01% to 20% by weight, relative to the total weight of the composition.

55. The composition according to claim 54, wherein the at least one cationic polymer is present in an amount ranging from 0.05% to 10% by weight, relative to the total weight of the composition.

56. The composition according to claim 55, wherein the at least one cationic polymer is present in an amount ranging from 0.1% to 5% by weight, relative to the total weight of the composition.

57. A process for the cosmetic treatment of keratinous substances, comprising applying to the keratinous substance an effective amount a detergent composition, comprising, in a cosmetically acceptable medium, at least one semi-crystalline polymer having a melting point of greater than or equal to 30° C., at least one oil, and at least one anionic and/or nonionic detergent surfactant, the composition being provided in the form of an oil-in-water emulsion, and rinsing, after an optional leave-in time.

58. The process according to claim 57, wherein the keratinous substances are hair.
